(19) United States
(12) Patent Application Publication
(10) Pub. No.: US 2013/0011730 A1
(43) Pub. Date: Jan. 10, 2013

(54) POSITIVE ELECTRODE FOR RECHARGEABLE LITHIUM BATTERY AND RECHARGEABLE LITHIUM BATTERY

(75) Inventors: Tae-Hyun Bae, Yongin-si (KR); Woo-Cheol Shin, Yongin-si (KR); Sang-Il Han, Yongin-si (KR); Jung-Yi Yu, Yongin-si (KR); Mi-Hyun Lee, Yongin-si (KR)

(73) Assignee: SAMSUNG SDI CO., LTD., Yongin-si (KR)

(21) Appl. No.: 13/299,558

(22) Filed: Nov. 18, 2011

(30) Foreign Application Priority Data
Jul. 5, 2011 (KR) 10-2011-0066585

(51) Int. Cl. H01M 4/66

(52) U.S. Cl. 429/211

(57) ABSTRACT

Disclosed is a positive electrode for a rechargeable lithium battery and a rechargeable lithium battery including the same. The positive electrode includes a current collector; a positive active material layer including a positive active material and a vanadium oxide; and a vanadium oxide-contained coating layer formed between the current collector and the positive active material layer.

### CLAIM OF PRIORITY

This application makes reference to, incorporates the same herein, and claims all benefits accruing under 35 U.S.C. §119 from an application earlier filed in the Korean Intellectual Property Office on 5 Jul. 2011 and there duly assigned Serial No. 10-2011-0066585.

### BACKGROUND OF THE INVENTION

1. Field of the Invention

One embodiment of the present invention relates to a positive electrode of a rechargeable lithium battery and a rechargeable lithium battery including the positive electrode, and more particularly, to a positive electrode of a rechargeable lithium battery having excellent capacity and output characteristics.

2. Description of the Related Art

Lithium rechargeable batteries have recently drawn attention as a power source to drive small portable electronic devices. Lithium rechargeable batteries generally use an organic electrolyte solution and thereby have twice or more the discharge voltage in comparison with conventional batteries using an alkaline aqueous solution. Accordingly, lithium rechargeable batteries have higher energy density in comparison with the conventional batteries.

Intensive research has been made for positive active materials of the rechargeable lithium battery. For example, lithium-transition element composite oxides, such as LiCoO₂, LiMn₂O₄, LiNi₁₋ₓCoₓO₂ (0<x<1), and other similar materials, which are capable of intercalating lithium, may be used as the positive active materials for the rechargeable lithium battery.

Various carbon-based materials may be used as the negative active materials of the rechargeable lithium battery. The carbon-based material may include artificial graphite, natural graphite, and hard carbon, which can intercalate and deintercalate lithium ions; metal-based materials such as Si; or lithium composite compounds such as lithium vanadium oxide.

The above information disclosed in this Background section is only for enhancement of understanding of the background of the invention and therefore it may contain information that does not form the prior art that is already known in this country to a person of ordinary skill in the art.

### SUMMARY OF THE INVENTION

One aspect of the present invention provides a positive electrode for a rechargeable lithium battery having excellent capacity and output characteristics.

Another aspect of the present invention provides a rechargeable lithium battery including the positive electrode.

In accordance with one embodiment of the present invention, a positive electrode for a rechargeable lithium battery may include a current collector; a positive active material layer including a positive active material and a vanadium oxide; and a vanadium oxide-contained coating layer formed between the current collector and the positive active material layer.

The coating layer may have a thickness of 2000 nm to 3000 nm.

The positive active material layer may include the vanadium oxide in 8 wt % to 12 wt % based on the entire weight of the positive active material and the vanadium oxide.

The vanadium oxide included in the coating layer may have a grain size of 500 nm to 1000 nm.

The vanadium oxide may be VO₂, V₂O₃, V₂O₅, or a combination thereof.

The positive active material may be a compound reversibly capable of intercalating and deintercalating lithium.

In accordance with another embodiment, a rechargeable lithium battery may include the above mentioned positive electrode; a negative electrode including a negative active material; and a non-aqueous electrolyte.

Hereinafter, further embodiments will be described in detail.

The positive electrode for a rechargeable lithium battery constructed with one embodiment may have a low electric resistance to provide excellent volume energy density and loading characteristics.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of a positive electrode for a rechargeable lithium battery constructed with one embodiment of the present invention;

FIG. 2 is a schematic view of a rechargeable lithium battery constructed with another embodiment of the present invention;

FIG. 3A is a SEM photograph of VO₂ coating layer obtained from Example 1;

FIG. 3B is a SEM photograph of positive active material layer obtained from Example 1;

FIG. 4 is a graph showing the experimental cycle-life characteristics of rechargeable lithium battery using each positive electrode obtained from Example 1 and Comparative Examples 1 to 3;

FIG. 5 is a graph showing the experimental capacity recovery characteristic of a rechargeable lithium battery using the positive electrode obtained from Example 1; and

FIG. 6 is a flow chart showing the manufacturing process of the positive electrode of Example 1.

### DETAILED DESCRIPTION OF THE INVENTION

Exemplary embodiments of this disclosure will hereinafter be described in detail. However, these embodiments are exemplary, and this disclosure is not limited thereto.

In accordance with one embodiment of the present invention, a positive electrode for a rechargeable lithium battery may include a current collector; a positive active material layer including a positive active material and a vanadium oxide; and a vanadium oxide-contained coating layer formed between the current collector and the positive active material layer.

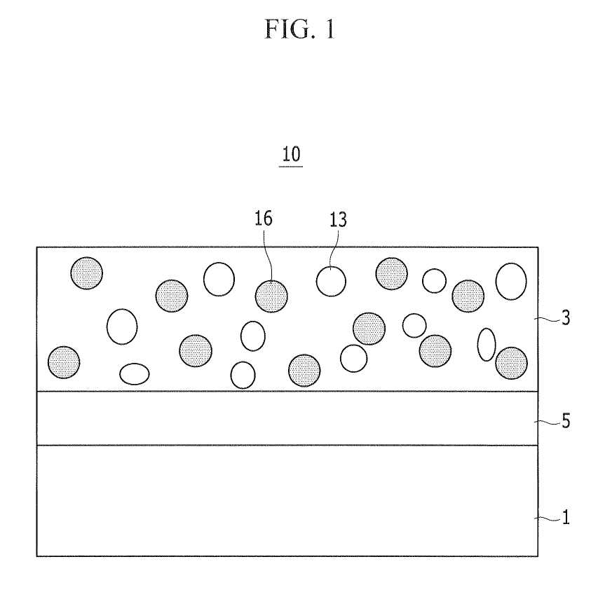

FIG. 1 is a schematic view showing the structure of positive electrode for a rechargeable lithium battery constructed with one embodiment of the present invention. As shown in FIG. 1, the positive electrode 10 constructed with one embodiment of the present invention includes a current collector 1, a positive active material layer 3, and a coating layer 5 disposed between the current collector 1 and the positive active material layer 3.

The positive active material layer 3 includes a positive active material 13 and a vanadium oxide 16. The vanadium oxide 16 is a material having characteristics of higher voltage, higher energy density, and wider reversible insertion region in comparison with other inorganic compounds, such as Al₂O₃, MgO, SiO₂ or the like. When the vanadium oxide 16 is mixed with positive active material 13 to provide a positive active material layer 3, lithium ions may be easily intercalated and diffused; as a result, the capacity and output of the rechargeable lithium battery using the positive electrode may be improved. The vanadium oxide 16 may be physically mixed with positive active material 13, and the vanadium oxide 16 does not perform any chemical reaction with positive active material 13. When the positive active material layer 3 includes other inorganic oxide such as Al₂O₃, MgO, SiO₂ or the like other than vanadium oxide 16, the reliability and the cycle-life characteristics of the battery may deteriorate.

The vanadium oxide may be VO₂, V₂O₃, V₂O₅, or a combination thereof. The vanadium oxide may be VO₂ in the view of the capacity and cycle-life characteristics. Since the size of the vanadium oxide rarely affects on the effects of the present invention, the vanadium oxide may have any size.

The positive active material layer 3 may include the vanadium oxide 16 in a range of from 8 wt % to 12 wt % based on the entire weight of the positive active material 13 and the vanadium oxide 16. When the vanadium oxide is included within the above mentioned range, the capacity and cycle-life characteristics of the battery may be enhanced.

The positive active material layer 3 may include the positive active material 13 and the vanadium oxide 16 in a range of from 70 wt % to 80 wt % based on the entire weight of positive active material layer 3.

The positive active material may be a compound capable of reversibly intercalating and deintercalating lithium (“lithiated intercalation compound”). Examples of positive active material may be compounds represented by one of the following formulas. LiₐA_{1-b}X_{b}D₂ (0.90≦a≦1.8, and 0≦b≦0.5); LiₐA_{1-b}X_{b}O_{2-c}D_{c} (0.90≦a≦1.8, 0≦b≦0.5, and 0≦c≦0.05); LiₐE_{1-b}X_{b}O_{2-c}D_{c} (0.90≦a≦1.8, 0≦b≦0.5, and 0≦c≦0.05); LiₐE_{2-b}X_{b}O_{4-c}D_{c} (0.90≦a≦1.8, 0≦b≦0.5, and 0≦c≦0.05); LiₐNi_{1-b-c}Co_{b}X_{c}D_{α} (0.90≦a≦1.8, 0≦b≦0.5, 0≦c≦0.5, and 0≦α≦2); LiₐNi_{1-b-c}Co_{b}X_{c}O_{2-α}T_{α} (0.90≦a≦1.8, 0≦b≦0.5, 0≦c≦0.05, and 0≦α≦2); LiₐNi_{1-b-c}Co_{b}X_{c}O_{2-α}T₂ (0.90≦a≦1.8, 0≦b≦0.5, 0≦c≦0.05, and 0≦α≦2); LiₐNi_{1-b-c}Mn_{b}X_{c}D_{α} (0.90≦a≦1.8, 0≦b≦0.5, 0≦c≦0.05, and 0≦α≦2); LiₐNi_{1-b-c}Mn_{b}X_{c}O_{2-α}T_{α} (0.90≦a≦1.8, 0≦b≦0.5, 0≦c≦0.05, and 0≦α≦2); LiₐNi_{1-b-c}Mn_{b}X_{c}O_{2-α}T₂ (0.90≦a≦1.8, 0≦b≦0.5, 0≦c≦0.05, and 0≦α≦2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GₑO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8, 0.001≦b≦0.1); LiₐCoG_{b}O₂ (0.90≦a≦1.8, and 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, and 0.001≦b≦0.1); LiₐMn_{1-g}G_{g}PO₄ (0.90≦a≦1.8, and 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiFePO₄.

In the above formulas, A may be selected from the group consisting of Ni, Co, Mn, and a combination thereof; X may be selected from the group consisting of Al, Ni, Co, Mn, Cr, Fe, Mg, Sr, V, a rare earth element, and a combination thereof; D may be selected from the group consisting of O, F, S, P, and a combination thereof; E may be selected from the group consisting of Co, Mn, and a combination thereof; T may be selected from the group consisting of F, S, P, and a combination thereof; G may be selected from the group consisting of Al, Cr, Mn, Fe, Mg, La, Ce, Sr, V, and a combination thereof; Q may be selected from the group consisting of Ti, Mo, Mn, and a combination thereof; Z may be selected from the group consisting of Cr, V, Fe, Sc, Y, and a combination thereof; and J may be selected from the group consisting of V, Cr, Mn, Co, Ni, Cu, and a combination thereof.

The compound of the positive active material may include a surface-treatment layer disposed on the surface, or may be mixed with another compound having a surface-treatment layer. The surface-treatment layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for a surface-treatment layer may be amorphous or crystalline. The coating element included in the surface-treatment layer may include Mg, Al, Co, K, Na, Ca, Si, Ti, V, Sn, Ge, Ga, B, As, Zr, or a mixture thereof. The surface-treatment layer may be formed by a method having no adverse influence on properties of a positive active material by including these elements in the compound. For example, the method may include any coating method such as spray coating, dipping, and the like, but is not illustrated in more detail, since it is well-known to those who work in the related field.

The positive active material layer may further include a conductive material and a binder as well as the positive active material and vanadium oxide. The binder and conductive material may be included in amounts of about 10 to about 15 wt % based on the total weight of the positive active material layer, respectively.

The binder may improve binding properties of the positive active material particles to one another, and also with a current collector. Examples of the binder include polyvinyl alcohol, carboxylmethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may be included to improve electrode conductivity of the positive active material layer. Any electrically conductive material may be used as the conductive material except the conductive materials which may cause a chemical change of the positive active material layer. Examples of the conductive material include carbon-based materials such as natural graphite, artificial graphite, carbon black, acetylene black, ketjen black, carbon fiber, and the like; metal-based materials including a metal powder or a metal fiber of copper, nickel, aluminum, silver, and the like; conductive polymers such as polyphenylene derivatives; or mixtures thereof.

The coating layer 5 is a vanadium oxide-contained layer which is formed with a vanadium oxide. When the vanadium oxide is disposed between the current collector 1 and the positive active material layer 3, the vanadium oxide may suppress permeating the electrolyte into the current collector 1 while enhancing the capacity of the active material to prevent the corrosion of current collector 1. In addition, the vanadium oxide of the coating layer 5 may have a grain size of 500 nm to 1000 nm. Since the coating layer 5 containing the vanadium oxide having the grain size is disposed between the current collector 1 and the positive active material layer 3, the coating layer 5 may improve the adherence between the current collector 1 and the active material layer 3 in order to provide a battery with higher capacity and higher power.

Examples of vanadium oxide may include VO₂, V₂O₃, V₂O₅, or a combination thereof. The vanadium oxide may be VO₂ in the view of the capacity and the cycle-life characteristics.

The coating layer 5 may have a thickness of 2000 nm to 3000 nm. It The coating layer 5 with the above ranged thickness may well maintain the electrical conductivity between the current collector and the active material while further improving the anti-corrosion effect of current collector.

In accordance with one embodiment of the present invention, the vanadium oxide-contained coating layer 5 may be formed by a deposit process. For example, the vanadium oxide-contained coating layer 5 may be formed by a pulsed laser deposition (PLD) process. The pulsed laser deposition process is a process of irradiating laser onto a vanadium target in a chamber and depositing a vanadium particle on the surface of the current collector 1. The vanadium target may include VO₂, V₂O₃, V₂O₅, or a combination thereof.

The deposition process may be performed under the conditions shown in the following Table 1. The condition of deposition is an important factor affecting the thickness and the composition of vanadium oxide. When the deposition process is performed under the conditions shown in the following Table 1, the deposition process may well provide the structure of vanadium oxide.

TABLE 1

| | |
|---|---|
| Laser energy (Laser fluence) | 3 J/cm² to 5 J/cm² |
| Background gas | O₂ |
| Deposition pressure | 9.5 mTorr to 11 mTorr |
| Substrate temperature | 380° C. to 400° C. |
| Deposition time | 10 minutes to 13 minutes |

If the vanadium oxide-contained coating layer is obtained by a wet process, the performance of the battery may deteriorate since the coating layer is too thick.

In one embodiment of the present invention, the current collector 1 may be an Al foil, but is not limited thereto. In addition, the current collector 1 may have a thickness of 16 μm to 20 μm. When the current collector has the thickness within the above mentioned range, an appropriate amount of electrical current may be flown in the current collector in order to well maintain the efficiency during the charge and discharge of the battery and to provide the current collector with the appropriate physical reliability.

In accordance with another embodiment of the present invention, a rechargeable lithium battery may include the positive electrode; a negative electrode including a negative active material; and a non-aqueous electrolyte.

The negative electrode includes a negative active material layer including a negative active material and a binder and a current collector supporting the negative active material layer.

The binder of the negative electrode improves binding properties of negative active material particles with one another and with a current collector. The binder includes a non-water-soluble binder, a water-soluble binder, or a combination thereof.

The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes a styrene-butadiene rubber, an acrylated styrene-butadiene rubber, polyvinylalcohol, sodium polyacrylate, a copolymer including propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkali metal salts thereof. The alkali metal may be Na, K, or Li. The cellulose-based compound may be included in an amount of about 0.1 to about 3 parts by weight based on 100 parts by weight of the negative active material.

The current collector of the negative electrode includes a copper foil, a nickel foil, a stainless steel foil, a titanium foil, a nickel foam, a copper foam, a polymer substrate coated with a conductive metal, or combinations thereof.

The negative active material layer may further include a conductive material. The conductive material may be any electrical conductive material that is generally used for a rechargeable lithium battery. Examples of the conductive material include a carbon-based material such as natural graphite, artificial graphite, carbon black, acetylene black, ketjen black, and carbon fiber; a metal-based material such as a metal powder or a metal fiber including copper, nickel, aluminum, and silver; a conductive polymer such as a polyphenylene derivative; and a mixture thereof.

The positive electrode and negative electrode may be fabricated in a method including (1) mixing an active material, a binder, and optionally a conductive material in a solvent to prepare an active material composition, (2) coating the active material composition on a current collector, (3) drying the coated current collector, and (4) compressing the dried coated current collector. According to one embodiment of the present invention, the positive electrode may be formed with an additional coating layer.

The solvent includes N-methylpyrrolidone and the like, but is not limited thereto. In addition, when the negative electrode includes a water-soluble binder, the solvent for a negative electrode may be water. The electrode manufacturing method is well known in the art, so the detailed description is omitted.

The non-aqueous electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, an ester-based, an ether-based, a ketone-based, an alcohol-based, or an aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitrites such as R—CN (where R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent may include a mixture of a cyclic carbonate and a linear carbonate. The cyclic carbonate and the linear carbonate are mixed together in the volume ratio of 1:1 to 1:9. When the mixture is used as an electrolyte, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in the volume ratio of 1:1 to 30:1.

The aromatic hydrocarbon-based organic solvent may be an aromatic hydrocarbon-based compound represented by the following Chemical Formula 1.

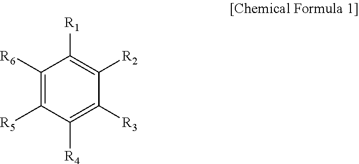

In Chemical Formula 1, R₁ to R₆ are independently hydrogen, a halogen, a C1 to C10 alkyl group, a C1 to C10 haloalkyl group, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate or an ethylene carbonate-based compound of the following Chemical Formula 2.

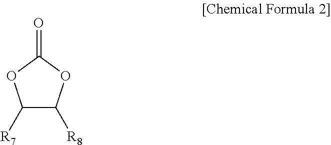

In Chemical Formula 2, R₇ and R₈ are independently hydrogen, a halogen, a cyano (CN), a nitro (NO₂), and a C1 to C5 fluoroalkyl, provided that at least one of R₇ and R₈ is a halogen, a cyano (CN), a nitro (NO₂), or a C1 to C5 fluoroalkyl, and R₇ and R₈ are not simultaneously hydrogen.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the additive for improving cycle life may be adjusted within an appropriate range.

The lithium salt supplies lithium ions in the rechargeable lithium battery, operates a basic operation of the rechargeable lithium battery, and improves lithium ion transportation between positive and negative electrodes of the rechargeable lithium battery. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from about 0.1 M to about 2.0 M. When the lithium salt is included at the above concentration range, electrolyte performance and lithium ion mobility may be enhanced due to optimal electrolyte conductivity and viscosity.

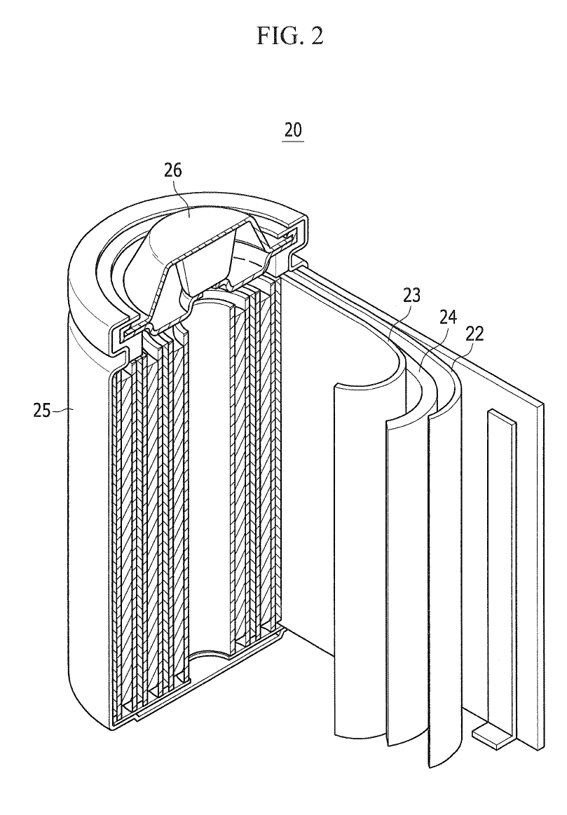

FIG. 2 is a schematic view of a schematic structure of a rechargeable lithium battery. FIG. 2 illustrates the rechargeable lithium battery 20, which includes a battery case 25 encasing a positive electrode 23, a negative electrode 22, a separator 24 interposed between the positive electrode 23 and negative electrode 22, an electrolyte (not shown) impregnating the positive electrode 23, the negative electrode 22, and a sealing member 26 sealing the battery case 25.

Examples of suitable materials forming the separator 24 include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, should not in any sense be interpreted as limiting the scope of the present invention.

### Example 1

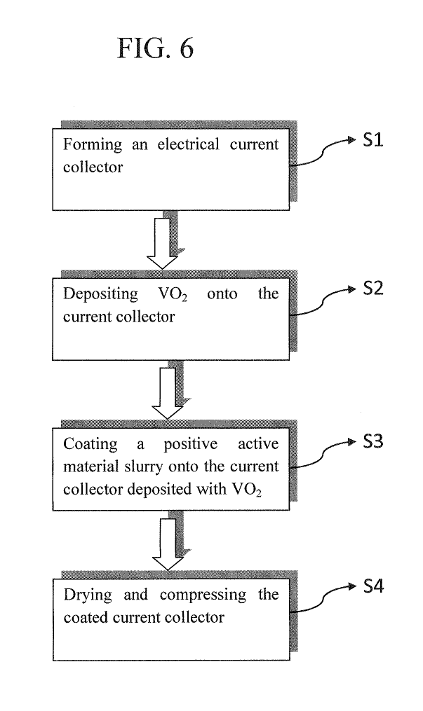

FIG. 6 is a flow chart showing the manufacturing process of positive electrode of Example 1.

A LiCoO₂ positive active material, a VO₂, carbon black conductive material, and a polyvinylidene fluoride binder were mixed in an N-methylpyrrolidone solvent at a ratio of 72 wt %, 8 wt %, 10 wt %, and 10 wt % to provide a positive active material slurry.

A current collector was formed by Al foil. (Step S1)

A current collector with a VO₂ coating layer was produced by the following process. A pulse laser deposition process was performed to a VO₂ target, and VO₂ is disposed on a substrate of the current collector by irradiating the laser beam on the VO₂ target under the conditions shown in the following Table 2. The resultant was dried to provide a VO₂ coating layer on an Al-foil current collector in a thickness of 20 μm. (Step S2)

TABLE 2

| | |
|---|---|
| Target | VO₂ |
| Laser type | Excimer laser, KrF 248 nm |
| Laser energy (Laser fluence) | 4 J/cm² |
| Repetition rate | 8 Hz |
| Target-substrate distance | 8.5 cm |
| Background gas | O₂ |
| Deposition pressure | 10 mTorr |
| Substrate | Eagle glass, Si 100/SiO₂, R-cut sapphire |
| Substrate temperature | 400° C. |
| Deposition time | 12.5 min |

The obtained VO₂ coating layer had a VO₂ grain size of about 800 nm and a thickness of 2500 nm.

A positive electrode in which the positive active material layer was formed on the VO₂ coating layer was fabricated according to the general process of coating the positive active material slurry on an Al foil formed with VO₂ coating layer and drying and compressing the same. (Steps S3 and S4)

SEM

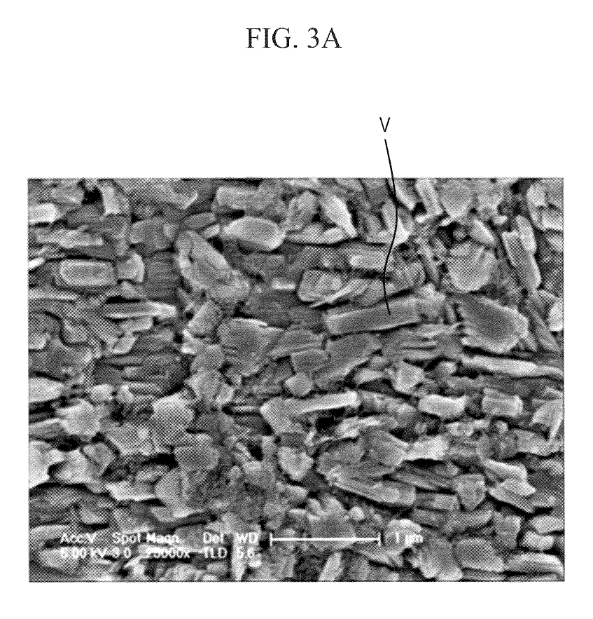

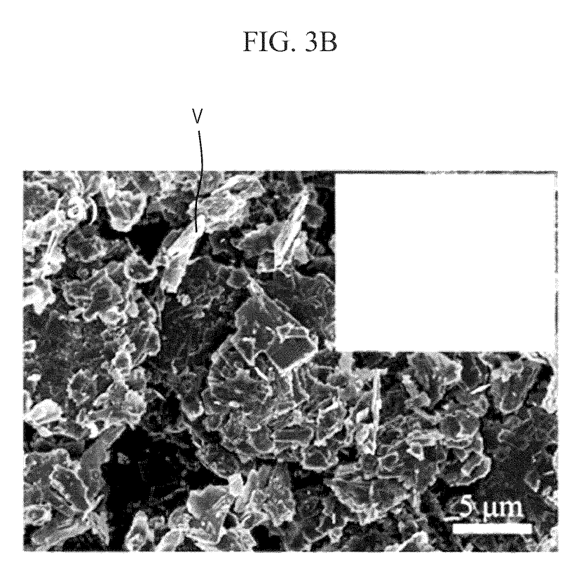

FIG. 3A and FIG. 3B show SEM photographs of the VO₂ coating layer 5 and the positive active material layer 3 obtained from Example 1, respectively. Referring to FIG. 3A and FIG. 3B, there were longish crystal V, which are monoclinic VO₂. Accordingly, SEM photographs of FIGS. 3A and 3B confirm that VO₂ was present in the positive active material constructed with the present invention.

### Comparative Example 1

A positive electrode was fabricated according to the general process of coating the positive active material slurry obtained from Example 1 on a Al-foil current collector having a thickness of 20 μm, drying and compressing the same.

### Comparative Example 2

A LiCoO₂ positive active material, a carbon black conductive material, and a polyvinylidene fluoride binder were mixed in an N-methylpyrrolidone solvent at a ratio of 80 wt %, 10 wt %, and 10 wt % to provide a positive active material slurry.

A positive electrode was fabricated according to the general process of coating the positive active material slurry on an Al-foil current collector having a thickness of 20 μm, drying and compressing the same.

### Comparative Example 3

A LiCoO₂ positive active material, FeₓO_{y} (x=2 and y=3), a carbon black conductive material, and a polyvinylidene fluoride binder were mixed in a N-methylpyrrolidone solvent at a ratio of 72 wt %, 8 wt %, 10 wt %, and 10 wt % to provide a positive active material slurry.

A positive electrode was fabricated according to the general process of coating the positive active material slurry on an Al-foil current collector having a thickness of 20 μm, drying and compressing the same.

Cycle Life Characteristic

A pouch type rechargeable lithium battery cell was fabricated using each positive electrode obtained from Example 1 and Comparative Examples 1 to 3, a negative electrode including a graphite negative active material, and an electrolyte. The electrolyte was prepared by dissolving 1.3M of LiPF₆ (lithium salt) in a mixed solvent of ethylene carbonate, ethylmethyl carbonate, and dimethyl carbonate (3:4:3 volume ratio).

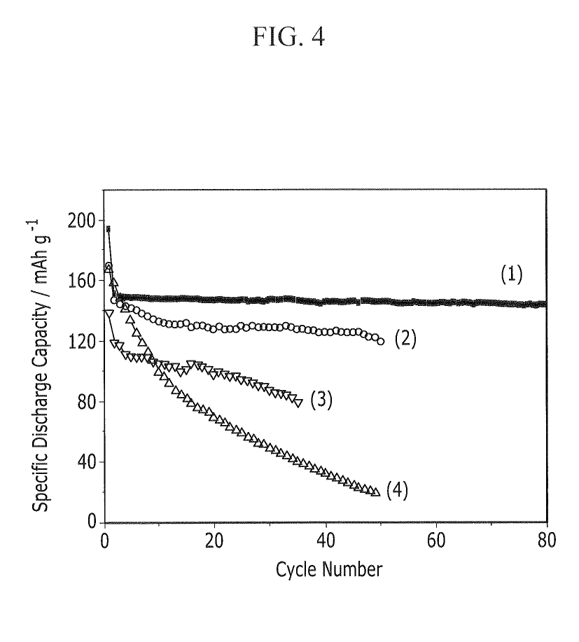

The rechargeable lithium battery cell was charged and discharged at 1 C for 80 times and measured for the discharge capacity, and the results are shown in FIG. 4. In FIG. 4, (1) shows the result of Example 1; (2) shows the result of Comparative Example 1; (3) shows the result of Comparative Example 2; and (4) shows the result of Comparative Example 3.

As shown in FIG. 4, in the case of the positive electrode obtained from Example 1 in which a vanadium oxide was added to a positive active material layer, and the vanadium oxide layer was disposed between the positive active material layer and the current collector, the initial capacity of the battery was improved and the capacity of the battery almost did not deteriorate even after the battery repeatedly performed the charge and discharge for 80 times.

On the other hand, in the case of the positive electrode obtained from Comparative Example 1 in which a vanadium oxide was added to a positive active material layer, and the vanadium oxide layer was not disposed between the positive active material layer and the current collector, the initial capacity of the battery of Comparative Example 1 was better and the capacity retention of the battery of Comparative Example 1 was slightly improved in comparison with the battery of Comparative Example 2 including the conventional positive electrode; however, the batteries of both Comparative Examples 1 and 2 deteriorated more significantly in comparison with the battery of Example 1.

In addition, in the case of Comparative Example 3 in which the positive active material layer included FeₓO_{y} instead of vanadium oxide, and the vanadium oxide layer was not disposed between the positive active material layer and the current collector, the initial capacity of the battery of Comparative Example 3 was slightly improved in comparison with Comparative Example 2; however, the capacity retention of the battery of Comparative Example 3 deteriorated more significantly in comparison with Comparative Example 2 including the conventional positive electrode.

Capacity Recovery Characteristic

The rechargeable lithium battery cell using the positive electrode obtained from Example 1 in the cycle life characteristics was repeatedly charged and discharged at 1 C for 30 times, at 2 C for 30 times, at 3 C for 30 times, at 4 C for 30 times, at 5 C for 30 times, at 7 C for 30 times, at 8 C for 30 times, at 9 C for 30 times, at 10 C for 30 times, and charged and discharged again at 1 C for 230 times.

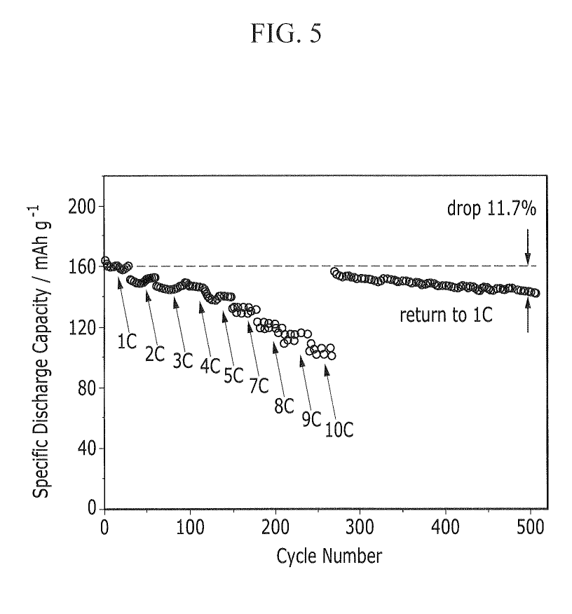

The discharge capacity of the battery of the Example 1 was measured when the battery was repeatedly charged and discharged again at 1 C for 230 times, and the results are shown in FIG. 5. In addition, the decremented rate of the measured discharge capacity to the initial discharge capacity was calculated, and the results are shown in FIG. 5. From the results as shown in FIG. 5, the decremented rate of the battery of the Example 1 was about 11.7%, which the capacity of the battery of the Example 1 was little decreased.

From the experimental results as shown in FIGS. 4 and 5, it is understood that the positive electrode of Example 1 improved the reliability and durability of current collector. In the cases of Comparative Examples 1 to 3, the positive electrodes of Comparative Examples 1 to 3 remarkably deteriorated the capacity retention as shown in FIG. 4, so the capacity recovery characteristic test was not performed.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive electrode of a rechargeable lithium battery, comprising:
a current collector;
a positive active material layer comprising a positive active material and a vanadium oxide; and
a coating layer disposed between the current collector and the positive active material layer, and the coating layer comprising the vanadium oxide.

2. The positive electrode for the rechargeable lithium battery of claim 1, the coating layer having a thickness of 2000 nm to 3000 nm.

3. The positive electrode for the rechargeable lithium battery of claim 1, the positive active material layer comprising the vanadium oxide in a range of from 8 wt % to 12 wt % based on the entire weight of the positive active material and the vanadium oxide.

4. The positive electrode for the rechargeable lithium battery of claim 1, the vanadium oxide included in the coating layer having a grain size of 500 nm to 1000 nm.

5. The positive electrode for the rechargeable lithium battery of claim 1, the vanadium oxide being selected from the group consisting of VO₂, V₂O₃, V₂O₅, and a combination thereof.

6. The positive electrode for the rechargeable lithium battery of claim 1, the positive active material being a compound capable of reversibly intercalating and deintercalating lithium.

7. A rechargeable lithium battery, comprising:
a positive electrode comprising a current collector, a positive active material layer comprising a positive active material and a vanadium oxide, and a coating layer disposed between the current collector and the positive active material layer with the coating layer comprising the vanadium oxide;
a negative electrode including a negative active material, with the negative electrode being electrically insulated from the positive electrode; and
a non-aqueous electrolyte impregnating the positive and negative electrodes.

8. The rechargeable lithium battery of claim 7, the coating layer having a thickness of 2000 nm to 3000 nm.

9. The rechargeable lithium battery of claim 7, the positive active material layer comprising the vanadium oxide in a range of from 8 wt % to 12 wt % based on the entire weight of the positive active material and the vanadium oxide.

10. The rechargeable lithium battery of claim 7, the vanadium oxide included in the coating layer having a grain size of 500 nm to 1000 nm.

11. The rechargeable lithium battery of claim 7, the vanadium oxide being selected from the group consisting of VO₂, V₂O₃, V₂O₅, and a combination thereof.

12. The rechargeable lithium battery of claim 7, the positive active material being a compound capable of reversibly intercalating and deintercalating lithium.

13. A positive electrode of a rechargeable lithium battery, comprising:
an electrical current collector;
a coating layer deposited directly on the electrical current collector, and the coating layer comprising a vanadium oxide; and
a positive active material layer disposed directly on the coating layer, the positive active material layer being different from the coating layer, and the positive active material layer comprising a physical mixture of a positive active material and the vanadium oxide.

14. The positive electrode for the rechargeable lithium battery of claim 13, the coating layer having a thickness of 2000 nm to 3000 nm.

15. The positive electrode for the rechargeable lithium battery of claim 13, the positive active material layer comprising the vanadium oxide in a range of from 8 wt % to 12 wt % based on the entire weight of the positive active material and the vanadium oxide.

16. The positive electrode for the rechargeable lithium battery of claim 13, the vanadium oxide included in the coating layer having a grain size of 500 nm to 1000 nm.

17. The positive electrode for the rechargeable lithium battery of claim 13, the vanadium oxide being selected from the group consisting of VO₂, V₂O₃, V₂O₅, and a combination thereof.

18. The positive electrode for the rechargeable lithium battery of claim 1, the positive active material being a compound capable of reversibly intercalating and deintercalating lithium.
